(19) United States
(12) Patent Application Publication
(10) Pub. No.: US 2026/0312169 A1
(43) Pub. Date: Oct. 8, 2026

(54) THERMAL MANAGEMENT OF MULTI-STRING, MULTI-PACK BATTERY SYSTEM

(71) Applicant: Caterpillar Inc., Peoria, IL (US)

(72) Inventors: Avinash Dongare, Bengaluru (IN); Alexander Charles Brown, Lincolnshire (GB); Stephen Edwards, Peterborough (GB); Sathvick Shiva Kumar, Mandya (IN)

(73) Assignee: Caterpillar Inc., Peoria, IL (US)

(21) Appl. No.: 19/172,832

(22) Filed: Apr. 8, 2025

(51) Int. Cl. H01M 10/633; B60L 58/27; H01M 10/48; H01M 10/615; H01M 10/625; H01M 10/6571; H02J 1/08

(52) U.S. Cl. CPC H01M 10/633; B60L 58/27; H01M 10/482; H01M 10/486; H01M 10/615; H01M 10/625; H01M 10/6571; H02J 1/084; B60L 2200/40; H01M 2220/20

(57) ABSTRACT

system for managing a plurality of battery strings of a battery system in a work machine is disclosed. The system includes a plurality of heating circuits associated with the plurality of battery strings, an external electrical power source electrically connectable with the plurality of battery strings and the plurality of heating circuits, and a controller. The controller is configured to electrically connect the plurality of heating circuits with one of the external electrical power source and a subset of the plurality of battery strings to cause activation of the plurality of heating circuits to control and maintain temperature of the plurality of battery strings within a predefined operating temperature range.

### TECHNICAL FIELD

The present disclosure relates to battery systems for use in work machines. More particularly, the present disclosure relates to a system and a method for thermal management of battery strings of a battery system.

### BACKGROUND

Battery systems (e.g., battery packs, or battery modules) are widely used in various applications, such as vehicles, equipment, and machinery, to store and provide electrical energy. A typical battery system may include multiple battery strings linked together in parallel. Each battery string may include energy storage cells grouped, for instance, in series to provide sustained electrical energy output to a load, such as propulsion motors of a vehicle.

To ensure optimal performance and longevity of these battery strings, it is essential to operate and maintain them within their specified temperature ranges. To achieve this, battery strings are equipped with temperature control circuits. Efficient management and utilization of these temperature control circuits are crucial for enhancing the overall performance of the battery system.

U.S. Pat. No. 11,815,970 discloses enabling system boot-up in low temperature environments. A laptop or other battery-powered computing device may include multiple batteries and a battery architecture that allows the multiple batteries to simultaneously discharge to thereby provide adequate power to boot the system in low temperature environments. The battery architecture may also allow a battery with a higher relative state-of-charge to charge another battery with a lower relative state-of-charge to thereby equalize the batteries' relative states-of-charge.

### SUMMARY OF THE INVENTION

In one aspect, the disclosure relates to a system for managing a plurality of battery strings of a battery system in a work machine. The system includes a plurality of heating circuits associated with the plurality of battery strings, an external electrical power source electrically connectable with the plurality of battery strings and the plurality of heating circuits, and a controller. The controller is configured to electrically connect the plurality of heating circuits with one of the external electrical power source and a subset of the plurality of battery strings to cause activation of the plurality of heating circuits to control and maintain temperature of the plurality of battery strings within a predefined operating temperature range.

In another aspect, the disclosure relates to a method for managing a plurality of battery strings of a battery system in a work machine. The method includes using a plurality of heating circuits associated with the plurality of battery strings. Further, the method includes determining charge levels of the plurality of battery strings, and temperature of the plurality of battery strings. In addition, the method includes electrically connecting, based on at least one of the charge levels and the temperature of the plurality of battery strings, the plurality of heating circuits with one of the external electrical power source and a subset of the plurality of battery strings to cause activation of the plurality of heating circuits to control and maintain the temperature of the plurality of battery strings within a predefined operating temperature range.

### BRIEF DESCRIPTION OF THE DRAWINGS

FIG. 1 is a side view of an exemplary work machine having a battery system, in accordance with an embodiment of the present disclosure;

FIG. 2 is a schematic illustration of a system for managing the battery system in the work machine, in accordance with an embodiment of the present disclosure; and

FIGS. 3 to 7 are flowcharts illustrating a method for managing the battery system, in accordance with an embodiment of the present disclosure.

### DETAILED DESCRIPTION

Reference will now be made in detail to specific embodiments or features, examples of which are illustrated in the accompanying drawings. Generally, corresponding reference numbers may be used throughout the drawings to refer to the same or corresponding parts, e.g., 1, 1′, 1″, 101 and 201 could refer to one or more comparable components used in the same and/or different depicted embodiments.

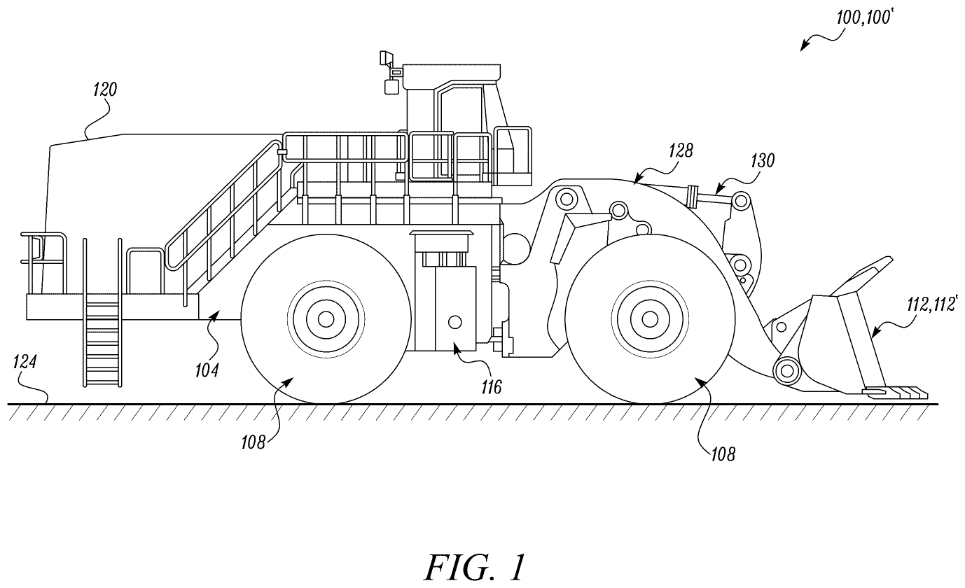

FIG. 1 depicts an exemplary work machine 100 (hereinafter referred to as “machine 100”) in accordance with this disclosure. The machine 100 may be a wheel loader 100′, as shown in FIG. 1. In other embodiments, however, the machine 100 may be other types of machines related to various industries, including, as examples, construction, agriculture, forestry, transportation, material handling, waste management, and so on. Accordingly, although a number of examples are described with reference to a wheel loader 100′, examples according to this disclosure are also applicable to other types of machines including graders, scrapers, dozers, excavators, compactors, material haulers like dump trucks, along with other example machine types.

The machine 100 includes a frame 104, traction members 108, an implement 112, and a battery system 116. The frame 104 may include a rigid structure to which every other component (e.g., the traction members 108, the implement 112, etc.,) of the machine 100 may be coupled to. The frame 104 may also include a compartment 120 configured to house, among other components, an electric motor (not shown) to propel the machine 100 over various terrain via the traction members 108. In an example, multiple electric motors are included in multiple enclosures at multiple locations of the machine 100.

The traction members 108 may be either in the form of wheels, crawlers, or a combination thereof. The traction members 108 may support the frame 104 (and thus, the machine 100) on a ground surface 124. A powering of the traction members 108 may cause the frame 104 (and thus, the machine 100) to move over the ground surface 124. The implement 112 includes a bucket 112′ configured to transfer material such as, soil or debris, from one location to another. The implement 112 may be operably coupled to the frame 104, for example, via a linkage assembly 128. The linkage assembly 128 may facilitate movement of the implement 112 relative to the frame 104 of the machine 100, or the ground surface 124.

The battery system 116 is configured to store and supply electrical energy to power operations of the machine 100. For example, the battery system 116 may be electrically coupled to the one or more electric motors (not shown) of the machine 100 to supply electrical energy to the one or more electric motors to propel the machine 100 over the ground surface 124. In another example, the battery system 116 may be electrically coupled to one or more pumps (not shown) of the machine 100 to power movement of corresponding actuators (e.g., an actuator 130) of the machine 100 to control the movement of the implement 112 relative to the frame 104 of the machine 100, or the ground surface 124.

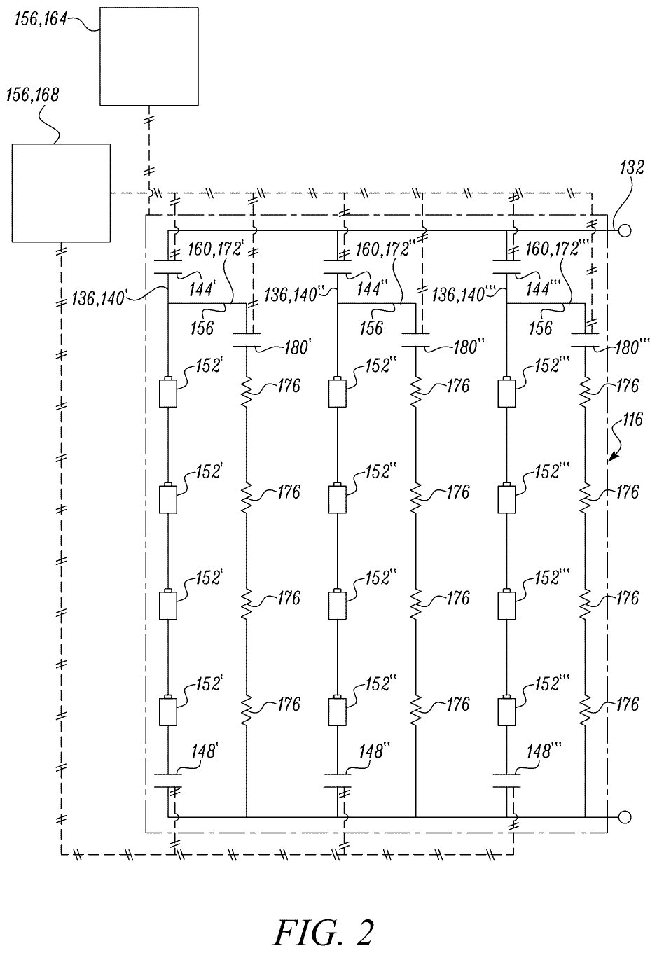

Referring FIG. 2, the battery system 116 is now discussed. The battery system 116 includes a power bus 132 and multiple battery strings (or packs) 136. The battery strings 136 are connectable in parallel to the power bus 132. In an example, as shown in FIG. 2, the battery system 116 includes three battery strings 136, namely—a battery string 140′, a battery string 140″, and a battery string 140′″. However, it should be noted that the battery system 116 may include a higher or a lower number of battery strings (or packs) 136 depending on application requirements.

For explanatory purposes, the battery string 140′ will now be explained in detail with reference to FIG. 2. However, it should be noted that the description provided below for the battery string 140′ may be equally applicable to the battery string 140″ and the battery string 140″′, without any limitations. The battery string 140′ may include string contactors, i.e., a positive contactor 144′ and a negative contactor 148′, to electrically connect the battery string 140′ to the power bus 132. The string contactors 144′, 148′ may include a mechanical push button, or a contact switch. Although not limited, the string contactors 144′, 148 may be normally maintained in an open condition to isolate the corresponding battery string 140′ from the power bus 132. Upon actuation, the string contactors 144′, 148′ may move to a closed condition to allow supply of electrical energy therethrough.

The battery string 140′ includes energy storage cells 152′ configured to undergo charging and discharging cycles to respectively store and supply electrical energy. Examples of the energy storage cells 152′ may include, but need not be limited to, a lithium-ion cell, an aluminum ion cell, a magnesium ion cell, a potassium ion cell, a sodium ion cell, a metal hydride cell, a nickel metal hydride cell, a cobalt metal hydride cell, a nickel-cadmium cell, a wet cell of any type, a dry cell of any type, combinations thereof, or the like. Examples of the lithium-ion cell may include, but need not be limited to, a lithium cobalt oxide cell, a lithium manganese oxide cell, a lithium nickel manganese cobalt oxide cell, a lithium iron phosphate cell, a lithium nickel cobalt aluminum oxide cell, and a lithium titanate cell.

The machine 100 operates generally under harsh work environment. As an example, the harsh work environment may include extreme cold weather conditions, such as an ambient temperature of minus 30 degree Celsius or below. To manage the battery strings 136 (e.g., the battery strings 140′, 140″, 140″′) of the battery system 116, for example, to control and maintain temperature of these battery strings 136 within a specified operating temperature range of the battery system 116, in one or more aspects of the present disclosure, a system 156 is disclosed. The system 156 includes multiple heating circuits 160, an external electrical power source 164, and a controller 168.

The heating circuits 160 are sources of thermal energy for the corresponding battery strings 136. In an example, as shown in FIG. 2, the system 156 includes three heating circuits 160, namely-a first heating circuit 172″, a second heating circuit 172″, and a third heating circuit 172″′. The first heating circuit 172′ is associated with the battery string 140′ and is configured to be activated to control and maintain temperature of the battery string 140′. The second heating circuit 172″ is associated with the battery string 140″ and is configured to be activated to control and maintain temperature of the battery string 140″. The third heating circuit 172′″ is associated with the battery string 140″′ and is configured to be activated to control and maintain temperature of the battery string 140″′.

For explanatory purposes, the first heating circuit 172′ will now be explained in detail with reference to FIG. 2. However, it should be noted that the description provided below for the first heating circuit 172′ may be equally applicable to the second heating circuit 172″ and the third heating circuit 172″, without any limitations. The first heating circuit 172′ may be configured to convert electrical energy into thermal energy that is provided to the one or more energy storage cells 152′ of the battery string 140′. The first heating circuit 172′ may include one or more resistive heating elements 176. Each resistive heating element 176 may be configured to receive and convert the electrical energy into thermal energy that may be used to increase the temperature of the energy storage cells 152′. Additionally, the resistive heating elements 176 may be metallic resistance heating elements, ceramic heating elements, semiconductor heating elements, thick film heating elements, polymeric heating elements, and/or other components configured to generate thermal energy.

Further, the first heating circuit 172′ may include a heater contactor 180′ to electrically connect the first heating circuit 172′ with one of at least one battery string 136 of the plurality of battery strings 136 and the external electrical power source 164, for example, via the power bus 132. Similarly, the second and third heating circuits 172″, 172″′ may respectively include heater contactors 180″, 180″′ to electrically connect the second and third heating circuits 172″, 172′″ with one of at least one battery string 136 of the plurality of battery strings 136 and the external electrical power source 164. The heater contactors 180, 180″, 180′″ may be mechanical push buttons, or contact switches. Although not limited, the heater contactors 180′, 180″, 180′″ may be normally maintained in an open condition to isolate the corresponding heating circuits 172 ,172″, 172″′ from the battery strings 136 and/or the power bus 132. Upon actuation, the heater contactors 180′, 180″, 180″′ may move to a closed condition to allow supply of electrical energy therethrough.

The external electrical power source 164 may be any type of device operable to store electrical energy and electrically connectable with the battery strings 136, for example, to exchange the electrical energy with (e.g., transmit electrical energy to) the battery strings 136 of the battery system 116, and electrically connectable with the heating circuits 160 to activate the heating circuits 160. In an example, the external electrical power source 164 may include one or more batteries (or fuel cells, or capacitors) associated with an external energy storage system (ESS). In another example, the external electrical power source 164 may include an alternate current supply source. In yet another example, the external electrical power source 164 may include one or more power conductors associated with a dynamic energy transfer (or charging-while-moving) system. In yet another example, the external electrical power source 164 may include one or more on-board battery systems (or packs) associated with one or more other work machines operating along with the machine 100.

The controller 168 is now discussed. The controller 168 may include a processor to process a variety of data (or inputs) such as the temperature data, operation schedule data, and the like. Examples of the processor may include, but are not limited to, an X86 processor, a Reduced Instruction Set Computing (RISC) processor, an Application Specific Integrated Circuit (ASIC) processor, a Complex Instruction Set Computing (CISC) processor, an Advanced RISC Machine (ARM) processor, or any other processor.

Further, the controller 168 may include a transceiver. According to various embodiments of the present disclosure, the transceiver may enable the controller 168 to communicate (e.g., wirelessly) battery string controllers, and the like, over one or more of wireless radio links, infrared communication links, short wavelength ultra-high frequency radio waves, short-range high frequency waves, or the like. Example transceivers may include, but not limited to, wireless personal area network (WPAN) radios compliant with various IEEE 802.15 (Bluetooth™) standards, wireless local area network (WLAN) radios compliant with any of the various IEEE 802.11 (WiFi™) standards, wireless wide area network (WWAN) radios for cellular phone communication, wireless metropolitan area network (WMAN) radios compliant with various IEEE 802.15 (WiMAX™) standards, and wired local area network (LAN) Ethernet transceivers for network data communication.

Also, the controller 168 may include a memory. Examples of the memory may include a hard disk drive (HDD), and a secure digital (SD) card. Further, the memory may include non-volatile/volatile memory units such as a random-access memory (RAM)/a read only memory (ROM), which may include associated input and output buses. The memory may be configured to store various other instruction sets, datasets, for various other functions of the controller 168, along with the set of instruction, datasets, discussed above.

The controller 168 may be configured to monitor various parameters associated with the battery system 116 and the battery strings 136 contained therein. In an embodiment, the controller 168 may monitor charge levels and temperatures related to the battery strings 136. For that, the controller 168 may be in communication with battery string controllers (not shown) associated with the battery strings 136 to receive information (or signals) indicative of the temperatures and charge levels of the battery strings 136.

Upon receiving the information (or signals) indicative of the temperatures of the battery strings 136, the controller 168 may determine whether the temperatures of the battery strings 136 are within a predefined operating temperature range of the battery system 116. In an embodiment, the pre-defined operating temperature range of the battery system 116 may be pre-stored in the memory of the controller 168.

Upon receiving the information (or signals) indicative of the charge levels of the battery strings 136, the controller 168 may determine whether the charge levels of the battery strings 136 are out of balance. For instance, upon determining that the charge level of the battery string 140′ (e.g., 80%) is significantly greater than the charge levels of the second battery string 140″ (e.g., 60%) and the third battery string 140″′ (e.g., 55%), respectively, the controller 168 may determine that the charge level of the battery string 140′ is out of balance with the charge levels of the second battery string 140″ and the third battery string 140″′. In an example, the controller 168 determines an out-of-balance state if the charge level of the battery string 140′ is greater than the charge level of the second battery string 140″ by a predefined threshold difference. In yet another example, the determination of an out-of-balance is made by the controller 168 by comparing the battery strings 136 with the highest charge level and the lowest charge level. When the difference between the highest charge level and the lowest charge level exceeds the predefined threshold difference, the controller 168 may determine that an out-of-balance condition exists.

In an example, the predefined threshold difference may be a percentage of the charge-level capacity of the battery string 136. For example, if the capacity of the battery string 140′ is 100 KWh, the predefined threshold difference may be 10 percent of the capacity, or 10 KWh. Thus, if the charge level of the battery string 140′ exceeds the charge level of the second battery string 140″ (or the third battery string 140″′) by 10 KWh, the controller 168 may determine that the charge levels are out of balance.

In other examples, the predefined threshold difference may be a percentage of the current charge level of the battery string 136. For example, if the current charge level of the battery string 140′ is 80 KWh, the predefined threshold difference may be 10 percent of the current charge level, or 8 KWh. Thus, if the charge level of the battery string 140′ exceeds the charge level of the second battery string 140″ (or the third battery string 140″′) by 8 KWh, the controller 168 may determine that the charge levels are out of balance.

Based on at least one of the parameters, e.g., the charge levels (balanced, or out-of-balance) and the temperatures of the battery strings 136, the controller 168 is configured to electrically connect one or more of the heating circuits 160 with one of the external electrical power source 164 and a subset (one or more) of the battery strings 136 to cause activation of the heating circuits 160. Once activated, the heating circuits 160 may convert the electrical energy into thermal energy which may heat the corresponding battery strings 136 in a manner to control and maintain the temperatures of the battery strings 136 within the predefined operating temperature range of the battery system 116.

In one exemplary application scenario in which the controller 168 determines that the battery strings 136 (or the battery system 116) are disconnected from the external electrical power source 164, the temperatures of the battery strings 136 are below the predefined operating temperature range, and the charge levels of the battery strings 136 are out-of-balance, the controller 168 may be configured to select a battery string 136 having the highest charge level (hereinafter referred to as “first battery string 136”) as the subset of the battery strings 136, and electrically connect the heating circuits 160 with the first battery string 136 having the highest charge level.

Using the first battery string 136 to activate the heating circuits 160 may cause the first battery string 136 to discharge or dissipate power, resulting in reduction of the charge level of the first battery string 136. In response to the reduction in the charge level of the first battery string 136 to a predefined level (determined based on the predefined threshold difference in the charge levels, as discussed above), the controller 168 may be configured to select next battery string 136 (hereinafter referred to as “second battery string 136”) with a second-highest charge level as the subset of the battery strings 136. The second-highest charge level may be greater than the predefined level. Further, the controller 168 may be configured to electrically disconnect the heating circuits 160 from the first battery string 136, and electrically connect the heating circuits 160 with the second battery string 136. The controller 168 may switchably connect and disconnect the heating circuits 160 with one or more of the battery strings 136 until the temperatures of the battery strings 136 are controlled and maintained within the predefined operating temperature range.

In another exemplary application scenario in which the controller 168 determines that the battery strings 136 (or the battery system 116) are disconnected from the external electrical power source 164, the temperatures of the battery strings 136 are below the predefined operating temperature range, and the charge levels of the battery strings 136 are balanced, the controller 168 may be configured to randomly select a battery string 136 as the subset of the battery strings 136, and electrically connect the heating circuits 160 with the selected battery string 136.

Using the selected battery string 136 to activate the heating circuits 160 may result in the reduction of the charge level of the selected battery string 136. Upon determining a difference between the charge level of the selected battery string 136 and the remaining battery strings 136 (of the battery system 116) exceeding the predefined threshold difference (discussed in detail above), the controller 168 may be configured to disconnect the heating circuits 160 from the selected battery string 136, select a next battery string 136 (as the subset) of the battery system 116, and electrically connect the heating circuits 160 with the next battery string 136. The controller 168 may continue to switchably connect and disconnect the heating circuits 160 with multiple battery strings 136 (of the battery system 116) until the temperatures of the battery strings 136 are controlled and maintained within the predefined operating temperature range.

In yet another exemplary application scenario in which the controller 168 determines that the battery strings 136 (or the battery system 116) are disconnected from the external electrical power source 164, the temperatures of the battery strings 136 are below the predefined operating temperature range, and the current charge levels of the battery strings 136 are balanced but below a threshold charge level required to activate the heating circuits 160 via discharging (as discussed above), the controller 168 may be configured to electrically connect the heating circuits 160 with the one or more of the battery strings 136 until the temperatures of the battery strings 136 are raised to a minimum temperature of the predefined operating temperature range.

Alternatively, the controller 168 may set a new predefined operating temperature range lower than the (current) predefined operating temperature range. The new predefined operating temperature range may be enough to operate the machine 100, for example, in a Limp-home mode. Further, the controller 168 may electrically connect the heating circuits 172′, 172″, 172″′ with the selected battery string 140′ to heat and raise the temperatures of the battery strings 140′, 140″, 140″′ to a new minimum temperature of the new predefined operating temperature range.

By lowering the predefined operating temperature range to the new predefined operating temperature range, the controller 168 may save the remaining internal energy of the battery system 116 (that was to be utilized for heating the battery strings 140′, 140″, 140″′ earlier). Accordingly, the controller 168 may prioritize usage of the remaining internal energy of the battery system 116 for machine operations over activation of the heating circuits 172′, 172″, 172″′. For instance, the controller 168 may electrically connect the battery system 116 (or the battery strings 140′, 140″, 140″′) with the loads, for example, the electric motors to propel the machine 100 to a charging station, or to a parking site, and the like.

In yet another exemplary application scenario in which the controller 168 determines that the battery strings 136 (or the battery system 116) are connected with the external electrical power source 164, the controller 168 may be configured to electrically connect the heating circuits 160 with the external electrical power source 164 to cause activation of the heating circuits 160 to raise the temperature of the battery strings 136 to a value greater than a maximum temperature of the predefined operating temperature range, for example, for deactivation of the heating circuits 160.

### Industrial Applicability

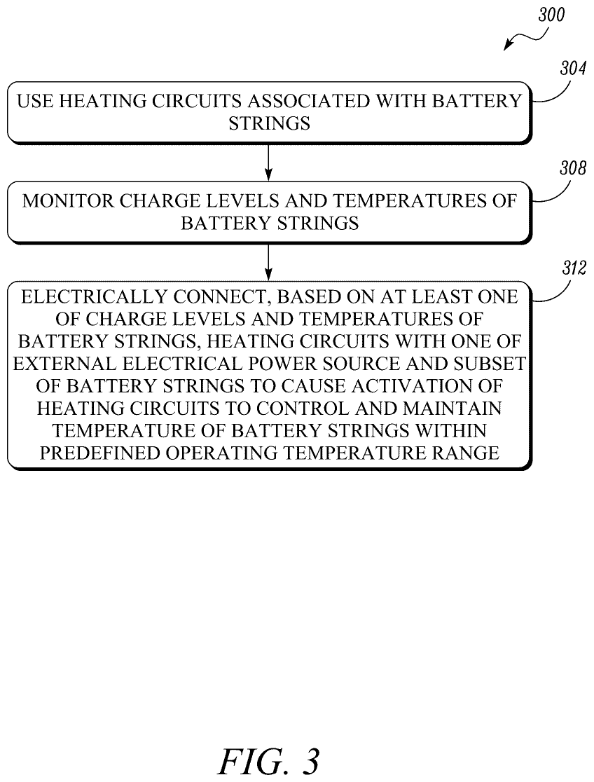

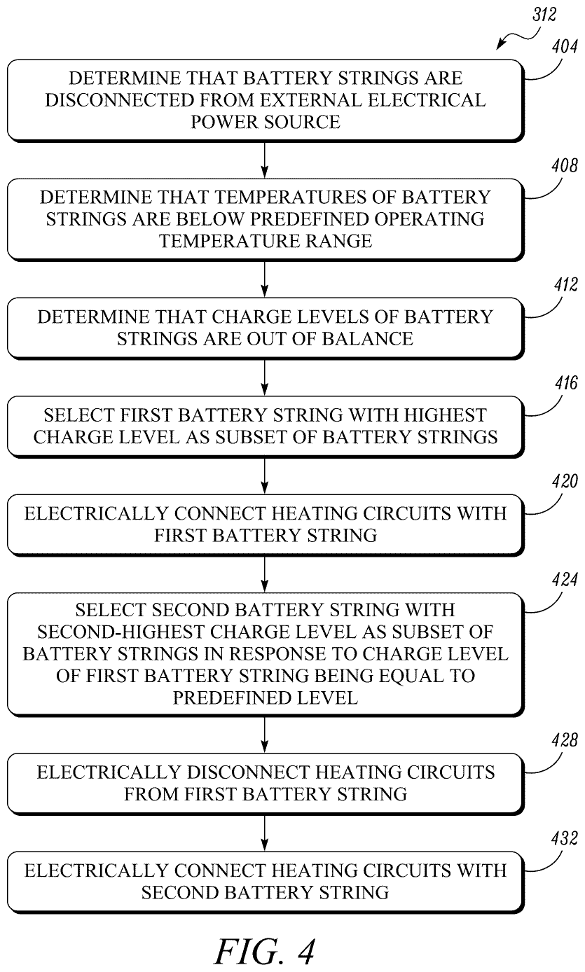

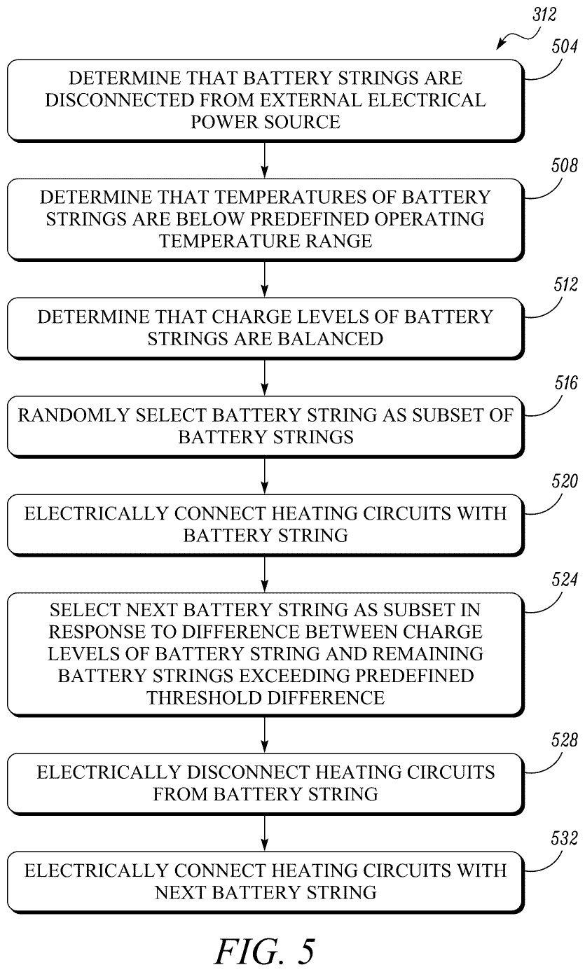

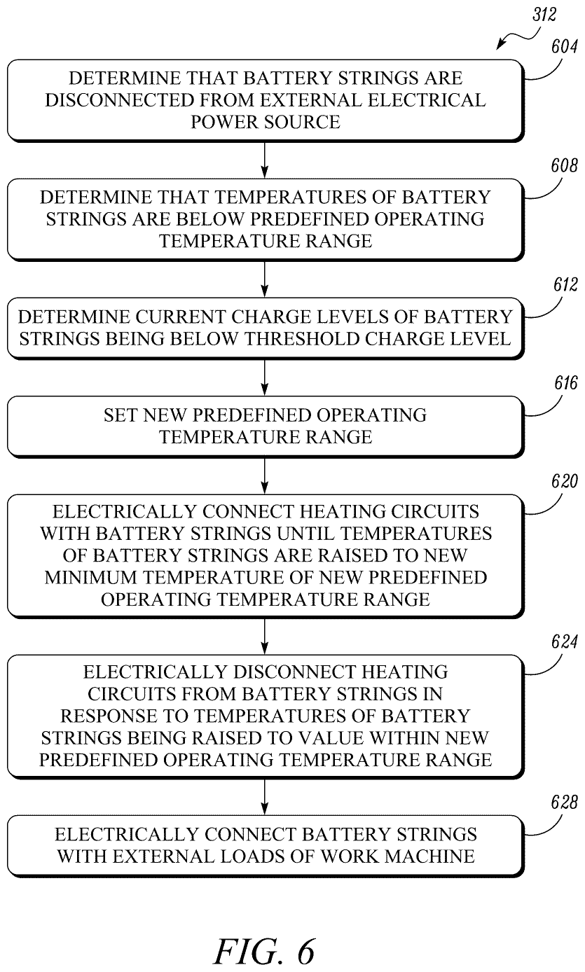

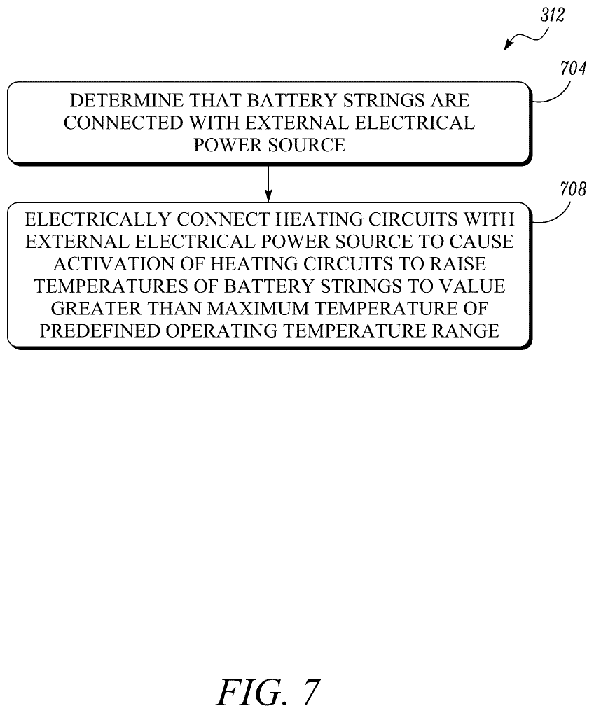

Referring to FIG. 3, an example method for managing battery strings of a battery system, for example, the battery strings 136 of the battery system 116, is discussed. The method is discussed by way of a flowchart 300 that illustrates exemplary stages (e.g., from 304 to 312) associated with the method. The method is also discussed in conjunction with FIGS. 1, 2, 4-7. It will be appreciated that the description in the method is exemplary in nature and that the steps can be performed in different executable details than what is set out below, as will be contemplated by a person skilled in the art based on the description of the present disclosure.

The method includes using heating circuits 160 associated with the battery strings 136 of the battery system 116 (step 304). The method further includes monitoring the charge levels and temperatures of the battery strings 136 (step 308). Further, the method includes electrically connecting, based on at least one of the charge levels and the temperatures of the battery strings 136, the heating circuits 160 with one of the external electrical power source and the subset of the battery strings 136 to cause activation of the heating circuits 160 to control and maintain temperature of the battery strings 136 within the predefined operating temperature range of the battery system 116 (step 312).

In an exemplary application scenario, upon determining that the battery strings 136 (or the battery system 116) are disconnected from the external electrical power source 164 (at step 404), the temperatures of the battery strings 140′, 140″, 140″′ are below 20° C.-30° C. (predefined operating temperature range) (at step 408), and the charge levels of the battery strings 136 are out of balance (at step 412), the controller 168 may select the battery string 140′ (hereinafter referred to as “first battery string 140′”) with the current charge level of 80% (highest charge level among the battery strings 136) as the subset (at step 416), and subsequently connect (electrically) the heating circuits 172, 172″, 172″′ with the first battery string 140′ (at step 420). To this end, the controller 168 may actuate the heater contactors 180′, 180″, 180′″, the positive contactors 144, 144″, 144″′, and the negative contactor 148′ to their closed positions to electrically connect the heating circuits 172′, 172″, 172″′ with the battery string 140′.

Upon reduction of the charge level of the first battery string 140′ to the predefined level (determined based on the predefined threshold difference in the charge levels, as discussed above), for example, from 80% charge level to 50% charge level, during the activation of the heating circuits 172, 172″, 172″′ via the first battery string 140′, the controller 168 may determine whether the temperatures of the battery strings 136 are within the predefined operating temperature range. If the temperatures of the battery strings 136 are still below the predefined operating temperature range, the controller 168 may disconnect the heating circuits 172′, 172″, 172″′ from the first battery string 140′ (at step 428), select the battery string 140″ (hereinafter referred to as “second battery string 140″”) with the current charge level of 60% (second-highest charge level among the battery strings 136) as the subset (at step 424), and subsequently connect (electrically) the heating circuits 172′, 172″, 172″′ with the second battery string 140″ (at step 432).

Similarly, upon reduction of the charge level of the second battery string 140″ to the predefined level, for example, from 60% charge level to 50% charge level, the controller 168 may electrically disconnect the heating circuits 172, 172″, 172″′ from the second battery string 140″, and electrically connect the heating circuits 172′, 172″, 172″′ with the next battery string 136, for example, the battery string 140″′ having 55% charge level. The controller 168 may continue to switchably connect and disconnect the heating circuits 172″, 172″, 172″′ with the first battery string 140′, the second battery string 140″, and the third battery string 140″ until the temperatures of the battery strings 140′, 140″, 140″′ are controlled and maintained within the predefined operating temperature range (e.g., 20° C.-30° C.).

In another exemplary application scenario, upon determining that the battery strings 136 (or the battery system 116) are disconnected from the external electrical power source 164 (at step 504), the temperatures of the battery strings 140′, 140″, 140″′ are below 20° C.-30° C. (predefined operating temperature range) (at step 508), and the charge levels of the battery strings 136 are balanced (e.g., 60%) (at step 512), the controller 168 may randomly select the battery string 140′ as the subset (at step 516), and subsequently connect (electrically) the heating circuits 172′, 172″, 172″′ with the selected battery string 140′ (at step 520). To this end, the controller 168 may actuate the heater contactors 180′, 180″, 180″′ the positive contactors 144′, 144″, 144″′, and the negative contactor 148′ to their closed positions to electrically connect the heating circuits 172, 172″, 172″′ with the selected battery string 140′.

When a difference between the charge level of the selected battery string 140′ and the remaining battery strings 140″, 140″ exceeds the predefined threshold difference (e.g., 10%), for example, upon reduction in the charge level of the selected battery string 140′ from 60% to 49% during usage, the controller 168 may disconnect the heating circuits 172, 172″, 172″′ from the selected battery string 140′, randomly select the next battery string 140″ (with 60% charge level) as the subset, and electrically connect the heating circuits 172″, 172″, 172′″ with the next battery string 140″ (at respective steps 524, 528, 532). The controller 168 may continue to switchably connect and disconnect the heating circuits 172′, 172″, 172″′ with the battery strings 140′, 140″, 140″′ until the temperatures of the battery strings 140′, 140″, 140″′ are controlled and maintained within the predefined operating temperature range.

In yet another application scenario, upon determining that the battery strings 136 (or the battery system 116) are disconnected from the external electrical power source 164 (at step 604), the temperatures of the battery strings 140′, 140″, 140″′ are below 20° C.-30° C. (predefined operating temperature range) (at step 608), and the charge levels of the battery strings 136 are balanced (e.g., 30%) but below a threshold charge level (e.g., 50%) required to activate the heating circuits 160 via discharging (at step 612), the controller 168 may set a new predefined operating temperature range (at step 616). The new predefined operating temperature range may be lower than the (current) predefined operating temperature range. For instance, the new predefined operating temperature range may define a new minimum temperature that may be lower than the minimum temperature of the previously defined operating temperature range. The new minimum temperature may be enough for the battery strings 140′, 140″, 140″″(or the battery system 116) to facilitate operations of the machine 100.

For example, upon determining that the battery strings 136 (or the battery system 116) are disconnected from the external electrical power source 164, the temperatures of the battery strings 140′, 140″, 140″′ are below 20° C.-30° C. (predefined operating temperature range), and the charge levels of the battery strings 136 are balanced (e.g., 30%) but below a threshold charge level (e.g., 50%) required to activate the heating circuits 160 via discharging, the controller 168 may set a new predefined operating temperature range of 16° C.-19° C., that is lower than the current predefined operating temperature range of 20° C.-30° C.

Subsequent to this, the controller 168 may electrically connect the heating circuits 172′, 172″, 172″′ with the battery string 140′ (randomly selected) to heat the battery strings 140′, 140″, 140″′ until the temperatures of the battery strings 140′, 140″, 140″′ are raised to a value within the new predefined operating temperature range (at step 620), for example, raised at least to the new minimum temperature of the new predefined operating temperature range. In an example, the controller 168 may electrically connect the heating circuits 172″, 172″, 172″′ with the selected battery string 140′ to heat and raise the temperatures of the battery strings 140′, 140″, 140″′ to the new minimum temperature (16° C.) of the new predefined operating temperature range.

Simultaneously, to keep the charge levels of the battery strings 136 in balance, the controller 168 may set a cutoff charge level (e.g., 25%) and discharge the selected battery string 140′ to cause activation of the heating circuits 172″, 172″, 172″′ until the current charge level of the selected battery string 140′ equalizes with the cutoff charge level. Once the current charge level of the selected battery string 140′ equalizes the cutoff charge level, the controller 168 may determine whether the temperatures of the battery strings 140′, 140″, 140″ is raised to the new minimum temperature. Upon determining that the temperatures of the battery strings 140′, 140″, 140′″ is still below the new minimum temperature, the controller 168 may disconnect the heating circuits 172, 172″, 172 *** from the selected battery string 140′, and connect the heating circuits 172″, 172″, 172′″ with the next battery string, for example, with the battery string 140″. The controller 168 may perform the switching when no electrical load is connected to the battery system 116. The controller 168 may continue to switchably connect and disconnect the heating circuits 172, 172″, 172′″ with the battery strings 140′, 140″, 140″′ until the temperatures of the battery strings 140′, 140″, 140″′ equalizes with the new minimum temperature of the new predefined operating temperature range.

By lowering the predefined operating temperature range to the new predefined operating temperature range, the controller 168 may save the remaining internal energy of the battery system 116 (that was to be utilized for heating the battery strings 140′, 140″, 140″′ earlier) and prioritize the saved internal energy for machine operations, for example, to operate the machine in Limp-home mode. For instance, upon determining that the temperatures of the battery strings 140′, 140″, 140″′ being raised to a value equal to the new minimum temperature (or within the new predefined operating temperature range) (at step 620), the controller 168 may electrically disconnect the heating circuits 172, 172″, 172″′ with the battery string 140′ (or the battery strings 140″, 140″′) (at step 624), and electrically connect the one or more of the battery strings 140′, 140″, 140″′ with the external loads of the machine 100 to facilitate the machine 100 to perform operations (at step 728). In this manner, the controller 168 may prioritize usage of the remaining internal energy of the battery system 116 (i.e., the remaining low charge levels of the battery strings 136) for machine operations over activation of the heating circuits 172′, 172″, 172″′ to cause further heating of the battery strings 140′, 140″, 140″′. For instance, the controller 168 may electrically connect the battery system 116 (or the battery strings 140′, 140″, 140″′) with the loads, for example, the electric motors to propel the machine 100 to a charging station, or to a parking site, and the like.

In yet another application scenario, upon determining that the battery strings 140′, 140″, 140″′ (or the battery system 116) are connected with the external electrical power source 164 (at step 704), the controller 168 may electrically connect the heating circuits 172′, 172″, 172″′ with the external electrical power source 164 to raise the temperature of the battery strings 136 to a value (e.g., 40° C.) greater than a maximum temperature (30° C.) of the predefined operating temperature range (20° C.-30° C.) (at step 708). By raising the temperatures of the battery strings 140′, 140″, 140″″to a value greater than the maximum temperature of the predefined operating temperature range, electrical energy of the battery strings 140′, 140″, 140″′ required to heat the battery system 116 (when the battery system 116 are disconnected from the external electrical power source 164 and being operated) may be saved.

Unless explicitly excluded, the use of the singular to describe a component, structure, or operation does not exclude the use of plural such components, structures, or operations or their equivalents. The use of the terms “a” and “an” and “the” and “at least one” or the term “one or more,” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B” or one or more of A and B”) is to be construed to mean one item selected from the listed items (A or B) or any combination of two or more of the listed items (A and B; A, A and B; A, B and B), unless otherwise indicated herein or clearly contradicted by context. Similarly, as used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

It will be apparent to those skilled in the art that various modifications and variations can be made to the system and/or the method of the present disclosure without departing from the scope of the disclosure. Other embodiments will be apparent to those skilled in the art from consideration of the specification and practice of the system and/or the method disclosed herein. It is intended that the specification and examples be considered as exemplary only, with a true scope of the disclosure being indicated by the following claims and their equivalent.

1. A system for managing a plurality of battery strings of a battery system in a work machine, the system comprising:
a plurality of heating circuits associated with the plurality of battery strings;
an external electrical power source electrically connectable with the plurality of battery strings and the plurality of heating circuits; and
a controller configured to:
determine that a temperature of the plurality of battery strings is below a predetermined operating temperature range,
determine whether charge levels of the plurality of battery strings are out of balance or in balance, and
electrically connect one or more of the plurality of heating circuits with subset of the plurality of battery strings to cause activation of the one or more heating circuits to control and maintain the temperature of the plurality of battery strings withinthe predefined operating temperature range,
wherein the controller is configured to selectively implement a plurality of battery charge level control schemes performed under condition where the temperature of the plurality of battery strings is determined to be below the predefined operating temperature range,
wherein a first battery charge level control scheme is performed under a first condition where the charge levels of the plurality of the plurality of battery strings are determined to be out of balance and includes successively connecting and disconnecting different battery strings of the plurality as the subset starting from a first battery string having a highest charge level and proceeding according to a second battery string having a next highest charge level, and
wherein a second battery charge level control scheme is performed under a second condition where the charge levels of the plurality of battery strings are determined to be in balance and includes successively connecting and disconnecting different battery strings as the subset starting from a randomly selected one of the battery strings and proceeding to a next of the battery strings based on a predefined charge level threshold difference associated with said selected one of the battery strings relative to remaining ones of the plurality of battery strings.

2. The system of claim 1, wherein the controller is configured to:
determine that the plurality of battery strings is disconnected from the external electrical power source prior to performing the first battery charge level control scheme.

3. The system of claim 1, wherein the controller is configured to operate as follows for the first battery charge level control scheme:
select the second battery string with the second-highest charge level as the subset of the plurality of battery strings in response to charge level of the first battery string decreasing to be equal to a predefined level, the second-highest charge level being greater than the predefined level;
electrically disconnect the one or more heating circuits from the first battery string; and
electrically connect the one or more heating circuits with the second battery string.

4. The system of claim 1, wherein the controller is configured to:
determine that the plurality of battery strings is disconnected from the external electrical power source prior to performing the second battery charge level control scheme.

5. The system of claim 1, wherein the controller is configured to operate as follows for the second battery charge level control scheme:
select the next battery string as the subset of the plurality of battery strings in response to a difference between the charge levels of the first battery string and one or more remaining battery strings exceeding the predefined charge level threshold difference;
electrically disconnect the one or more heating circuits from the first battery string; and
electrically connect the one or more heating circuits with the next battery string.

6. The system of claim 1, wherein the controller is configured to:
determine that the plurality of battery strings is disconnected from the external electrical power source;
determine that current charge levels of the plurality of battery strings are below a threshold charge level to use the charge of the battery strings to activate the plurality of heating circuits and the temperature of the plurality of battery strings is below the predefined operating temperature range;
set a new predefined operating temperature range, the new predefined operating temperature range defining a new minimum temperature lower than a minimum temperature of the predefined operating temperature range; and
electrically connect the plurality of heating circuits with the plurality of battery strings until the temperature of the plurality of battery strings is raised to the new minimum temperature of the new predefined operating temperature range.

7. The system of claim 6, wherein, in response to the temperature of the plurality of battery strings being raised to a value within the new predefined operating temperature range, the controller is configured to:
electrically disconnect the plurality of heating circuits from the plurality of battery strings; and
electrically connect the plurality of battery strings with one or more external loads of the work machine to perform operations of the work machine.

8. The system of claim 1, wherein the controller is configured to:
determine that at least one of the plurality of battery strings is connected with the external electrical power source; and
electrically connect the one or more of the plurality of heating circuits with the external electrical power source to cause activation of the one or more of the plurality of heating circuits to raise the temperature of the plurality of battery strings to a value greater than a maximum temperature of the predefined operating temperature range.

9. The system of claim 1, wherein the battery system includes a power bus, and each of the plurality of battery strings includes string contactors to electrically connect to the power bus.

10. The system of claim 9, wherein each of the plurality of heating circuits includes a heater contactor to electrically connect a respective one of the heating circuits of the plurality of heating circuits with one of at least one battery string of the plurality of battery strings and the external electrical power source via the power bus.

11. A method for managing a plurality of battery strings of a battery system in a work machine, the method comprising:
monitoring a temperature of one or more of the plurality of battery strings to determine whether the temperature is below a predetermined operating temperature range;
monitoring charge levels of the plurality of battery strings;
electrically connecting, based on the charge levels and the temperature of the one or more battery strings, one or more of a plurality of heating circuits to cause activation to control and maintain the temperature of the one or more battery strings within the predefined operating temperature range,
wherein said electrically connecting includes a plurality of battery charge level control schemes performed under condition where the temperature of the one or more battery strings is determined to be below the predefined operating temperature range,
wherein a first battery charge level control scheme is performed under a first condition where the charge levels of the plurality of battery strings are determined to be out of balance,
wherein a second battery charge level control scheme is performed under a second condition where the charge levels of the plurality of the plurality of battery strings are determined to be in balance, and
wherein a third battery charge level control scheme is performed under a third condition where the charge levels of the plurality of battery strings are below a threshold charge level to use the charge of the battery strings to activate the one or more heating circuits.

12. The method of claim 11, wherein said electrically connecting the one or more heating circuits includes:
determining that the plurality of battery strings is disconnected from the external electrical power source prior to performing the first battery charge level control scheme.

13. The method of claim 11, wherein the first battery charge level control scheme includes:
selecting a first battery string of the plurality of battery strings having a highest charge level as the subset of the plurality of battery strings;
selecting a second battery string with a second-highest charge level as the subset of the plurality of battery strings in response to the charge level of the first battery string being equal to a predefined level, the second-highest charge level being greater than the predefined level;
electrically disconnecting the one or more heating circuits from the first battery string; and
electrically connecting at least one of the plurality of heating circuits with the second battery string after said electrically disconnecting for the first battery string.

14. The method of claim 11, wherein said electrically connecting the one or more heating circuits includes:
determining that the plurality of battery strings is disconnected from the external electrical power source prior to performing the second battery charge level control scheme.

15. The method of claim 11, wherein the second battery charge level control scheme includes:
selecting a next battery string as the subset of the plurality of battery strings in response to a difference between the charge levels of the first battery string and one or more remaining battery strings exceeding a predefined charge level threshold difference;
electrically disconnecting the one or more heating circuits from the first battery string; and
electrically connecting at least one of the plurality of heating circuits with the next battery string.

16. The method of claim 11, wherein the third battery charge level control scheme includes:
determining that current charge levels of the plurality of battery strings being-are below the threshold charge level to use the charge of the battery strings to activate the one or more heating circuits;
setting a new predefined operating temperature range, the new predefined operating temperature range defining a new minimum temperature lower than a minimum temperature of the predefined operating temperature range; and
electrically connecting the one or more heating circuits with the one or more battery strings until the temperature of the of one or more battery strings is raised to the new minimum temperature of the new predefined operating temperature range.

17. The method of claim 16, further comprising:
in response to the temperature of the one or more battery strings being raised to a value within the new predefined operating temperature range, electrically disconnecting the one or more heating circuits from the one or more battery strings; and
electrically connecting the plurality of battery strings with one or more external loads of the work machine to perform operations of the work machine.

18. The method of claim 11, wherein said electrically connecting the one or more heating circuits includes:
determining that at least one of the plurality of battery strings is connected with the external electrical power source; and
electrically connecting the one or more heating circuits source-to cause activation of the one or more heating circuits to raise the temperature of the one or more battery strings to a value greater than a maximum temperature of the predefined operating temperature range.

19. The method of claim 11, wherein the battery system includes a power bus, and each of the plurality of battery strings includes string contactors to electrically connect to the power bus.

20. The method of claim 19, wherein each of the plurality of heating circuits includes a heater contactor to electrically connect with one of at least one battery string of the one or more battery strings and the external electrical power source via the power bus.
